(19) United States
(12) Patent Application Publication
(10) Pub. No.: US 2023/0073876 A1
(43) Pub. Date: Mar. 9, 2023

(54) Systems And Methods For High Volume Processing Support Of Electronic Signature Tracking

(71) Applicant: Selex ES Inc., Greensboro, NC (US)

(72) Inventor: Todd Child, Greensboro, NC (US)

(21) Appl. No.: 17/940,677

(22) Filed: Sep. 8, 2022

Related U.S. Application Data
(60) Provisional application No. 63/242,143, filed on Sep. 9, 2021.

(51) Int. Cl. G06F 21/62; G06F 16/953; G06F 16/906

(52) U.S. Cl. CPC G06F 21/6218; G06F 16/953; G06F 16/906

(57) ABSTRACT

Embodiments of a system and method for data and security management are disclosed. An embodiment of the method may include capturing data relating to a plurality of targets from a plurality of sensors. The method may include correlating one or more targets to the data and classifying at least a portion of the data based on one or more correlations of the one or more targets. The method may include storing in a database the capture data according to one or more of partitioning, complex indexing, or pre-search statistical processing, with one or more of time, date, and location data with each associated data, wherein the data comprises high volumes of data received substantially continuous. The method may include retrieving a subset of the based on a user request. The method may include generating one or more graphical representations based on retrieved subsets of data to thereby enable targeted tracking.

### CROSS REFERENCE

The present patent application claims the benefit of U.S. Provisional Application No. 63/242,143, filed Sep. 9, 2021.

### INCORPORATION BY REFERENCE

The disclosures made in United Stated Provisional Application No. 63/242,143, filed Sep. 9, 2021, are specifically incorporated by reference herein as if set forth in their entirety.

### TECHNICAL FIELD

In one aspect, the present disclosure is directed to surveillance systems and methods of operation thereof, and more specifically, to high volume processing support systems for surveillance systems for the enhanced collection, storage, retrieval, search, and analysis of identifying data, including support for database partitioning, complex indexing, pre-search statistical processing, for surveillance systems. Other aspects also are described.

### BACKGROUND

Automated License Plate Readers (“ALPR”) typically are used for identifying vehicles in selected locations, e.g., for detecting traffic violations, collecting tolls, etc. . . . . However, existing ALPR systems are quite expensive and generally are used for identification of vehicles on roads, in parking lots, other vehicle throughways, etc. . . . . As data is collected by ALPR systems and/or other systems over the course of a typical day, thousands and up to millions of records are created.

It can be seen that a need exists for high volume processing support for surveillance systems that can be used for the collection, storage, retrieval, search, and analysis of identifying data.

The present disclosure is directed to the foregoing and other related, and unrelated, problems in the relevant art.

### SUMMARY

Briefly described, the present disclosure is directed to a system and methods for high volume processing support for intelligence databases built by surveillance systems for collecting, processing and correlating surveillance information such as electronic signatures and/or visual identifiers, such as digital images, photographs, video and other imaged data/information collected, such as by an ALPR site or system, to generate a high probability of associations or correlations between targets and collected electronic signature information from various devices, including, but not limited to Bluetooth, wireless, RFID, Wi-Fi, cellular and other electronic signature data. The systems and methods disclosed herein provide an ability to leverage large volumes of stored data, including stored target associated identifying data such as ALPR data, electronic signature information, etc., Such a surveillance system and intelligence database, and methods of processing large volumes of data stored therein can facilitate tracking and associating of indicators of common location(s) and movement(s) of identified/known targets throughout selected geographic areas or locations, as well as facilitate the high speed analysis of electronic signatures and/or other collected identifying information based on various factors (e.g., time, location, etc.). The high speed processing of such larger volumes of data can enable more rapid (and potentially substantially real-time) target tracking with increased confidence.

“Targets” generally refer to persons, vehicles, e.g., an automobile, or both, such a one or more persons within a vehicle. However, targets can include other objects, such as one or more electronic devices, e.g., cell phones or other communication devices, RFID and other sensors or transmitting devices internal to vehicles or as after-market additions, and/or various other, similar devices, without departing from the scope of the present disclosure.

According to aspects of the present disclosure, a surveillance system can include a plurality of collection systems or assemblies each located at selected geographic areas or locations. The collection systems generally are configured to capture or facilitate collection of information related to visual identifiers or electronic signatures associated with targets in or moving about the selected areas/locations. Each capture or collection may be associated with and/or stored with a particular time, date, and location data.

In some embodiments, the collection systems can include at least one sensor configured to collect or otherwise capture information related to visual identifiers and/or electronic signatures of targets. The visual identifiers can include visual vehicle identifiers, such as license plate information or other visual or imaged information associated with vehicles (e.g., stickers, patterns, position(s) of component parts, after-market added parts, damage, and/or various other markings, etc. . . . ) that can be used to distinguish or otherwise identify, detect or discern a target vehicle, etc. . . . . The electronic signatures can include an electronic signal or combination(s) of electronic signals emanating from transmitting electronic devices and which are associated with and/or can uniquely identify the targets in or moving about the selected areas/locations. Each captured visual identifier and/or electronic signature can include at least one record. Each record may be a particular size (e.g., the record, when stored in a non-transitory machine readable storage medium, takes up a particular amount of space in the non-transitory machine readable storage medium).

In addition, in some aspects, the surveillance system can include an intelligence system that is in communication with the plurality of collection systems. The intelligence system is configured to receive the information collected or captured by the collection systems (e.g., data points or packets of time and date stamped information in real time when targets get within proximity of the collection point systems), and to identify and/or track the targets based on this received information.

In embodiments, the intelligence system can include one or more correlation and search engines and an intelligence database in communication therewith. The one or more correlation and search engines can be configured to identify or extract the electronic signatures associated with the targets using the information collected by the collection systems and catalogue them in the intelligence database with certain identifying characteristics (e.g., geographical coordinates, time stamps, source manufacturer, source type and unique ID, etc.) allowing these identified electronic signatures to become unique, identifiable, and searchable. Further, the intelligence system may include a graphical or web-based user interface configured to allow a user to quickly visualize such data in various formats and based on a variety of factors (e.g., at a specified time of day, specified days of the week, over other various time periods, in specified locations, etc.).

In embodiments, the intelligence database can be managed via various structure, storage, and query techniques. The amount of records collected can be large. Such techniques ensure support for large datasets. The techniques can include indices, partitioning strategies, and summary data to make the implementation of high-volume ingestion, storage, retrieval, and disposal practical. Further, highly tuned storage and search algorithms can be utilized to process and store the millions of records. Further still, the purge of particular sets of data on a regular basis allows for manageable amounts of records. In an embodiment, the maintenance of data and user security can be performed through a domain structure. All types of data, security zones of collected data, users, and list of target identifiers can be managed through the domain structure. Privileges (e.g., type of access and who can access) can further be managed through the domain. Application of a set of externally visible methods through an application program interface (“API”) within the domain and group feature privilege model while maintaining performance at scale for high-volume data throughput.

The surveillance system is configurable to track, map, catalogue, etc., movements of the targets in real time as electronic signals emanating therefrom occur in proximity to the collection systems. The tracking information generated can be used to help confirm and/or authenticate a potential target identification, and further can be configured to generate alerts or notifications when certain targets are in proximity to the collection systems and can be used, as noted, in a number of user selectable visualizations.

The one or more correlation and search engines can infer relationships between electronic devices and targets based on consistency of correlation to identify/extract electronic signatures associated with targets.

For example, the one or more correlation and search engines can use frequency and consistency of electronic signals to determine the relative certainty of association of the transmitted electronic devices and targets to develop electronic signatures of the targets. That is, if the relative certainty or probability that a certain electronic signal or combination of electronic signals are associated with a target meets a prescribed threshold, the one or more correlation and search engines can identify an electronic signal or combinations of electronic signals as a specific electronic signature associated with that target. Further, such relationships and/or associations can be visualized in the graphical or web-based user interfaces.

The one or more correlation and search engines can be configured to filter or otherwise alter to the received electronic signatures, e.g., to reduce signal noise and facilitate identification or extraction of unique, identifying electronic signatures.

In embodiments, the one or more correlation and search engines can be configured to locate receipt of a visual identifier and correlated electronic signature to track the target.

In addition, or in the alternative, the one or more correlation and search engines will be configured to associate identifying electronic signatures with visual identifiers, such as a visual vehicle identifier, to allow independent tracking and location identification of targets based on the associated identifying electronic signatures. That is, once the system has records correlating electronic signatures associated with a specific visual vehicle identifier, e.g., a specific license plate number, the intelligence system will be able to detect the likely presence of a vehicle and its associated license plate without visual information, e.g., without the use of a camera.

Furthermore, the collection systems can be placed in locations or areas not associated with vehicular traffic, such that the intelligence system will be able to identify, and catalogue known electronic signatures away from the vehicles they have typically been associated with, e.g., for tracking, mapping, etc. of persons or electronic devices apart from vehicles.

In embodiments, the at least one sensor of each collection system can include a plurality of sensor assemblies. The sensor assemblies can include one or more cameras or camera systems configured to capture or facilitate collection of information related to vehicle identifiers, such as visual information related to a license plate of a vehicle or other visual vehicle identifiers.

In addition, the sensor assemblies can include one or more antennas or other signal receivers configured to capture information related to the electronic signatures. The one or more antennas can include a plurality of antennas, such as a Bluetooth® antenna, a Wifi antenna, a RFID antenna, or other RF antennas or combinations thereof, configured to capture information related to electronic signals associated with the targets.

In some embodiments, the collection systems can be used in conjunction with Automated License Plate Readers (“ALPR”) in certain areas, allowing the intelligence system to develop a subset of electronic signals, i.e., an electronic signature, associated with a license plate read at a moment in time and location. Electronic data points from less expensive collectors can then be used to provide more precise tracking than ALPR alone.

In some embodiments, the surveillance system can be configured to capture sample electronic signature information from a target, associate that information with the target's identification, and then search for or alert on receipts of similar electronic signature information at one of the collection point systems.

In additional embodiments, the surveillance system can be configured to allow for search inquiries or scans of suspect's electronic signatures to search known location data points in the database history, placing the suspect at those locations and times.

In still other embodiments, the surveillance system can be configured to allow for labeling of specific electronic signatures with a target and then alert or search for history of those specific electronic signatures in the database, placing the target at various locations.

In further embodiments, the surveillance system further can indicate or determine changes in association or travel of suspects or other individuals of interest based on variations in electronic signatures associated with a target or targets.

According to another embodiment of the disclosure, a surveillance system for data and security management may include one or more collection systems. The one or more collection systems may be configured to capture, via one or more sensors, data relating to a plurality of targets from a plurality of sensors. The surveillance system may include an intelligence system. The intelligence system may be configured to correlate data to one or more of the plurality of targets associated with the data. The intelligence system may further be configured to transmit one or more of the data, correlation, or associated one or more targets. The surveillance system may include a database. The database may be configured to include receive the one or more of the data, correlation, or associated one or more targets from one or more correlation and search engines. The database may be configured to classify the data based on one or more correlations of the one or more targets. The database may be configured to store the data captured via the one or more correlation and search engines according to one or more of partitioning, complex indexing, or pre-search statistical processing. The data may comprise high volumes of data received substantially continuously and in real-time. The data may also include one or more of time, date, and location data. The surveillance system may also include a user interface. The user interface may be configured to retrieve a subset of the data based on one or more of the time, date, and location data based on a user request. The user interface may further be configured to generate one or more graphical representations based on retrieved subsets of data to thereby enable targeted tracking and analysis.

In an embodiment, the data may also include one or more characteristics associated with the plurality of targets. The plurality of targets may comprise persons, vehicles, or electronic devices. The characteristics may comprise one or more of geographical coordinates, time stamps, source manufacturer, source type, unique ID, or electronic signature. The user request may include one or more of one or more specified targets, one or more times, one or more dates, one or more locations, or one or more characteristics. The electronic signature may comprise information from one or more of Bluetooth signals, wireless signals, RFID signals, Wi-Fi signals, or cellular signals. The database may be configured to remove or purge data classified as non-interest data after a selected period of time.

In another embodiment, the user interface may connect to the database via an application program interface (API). The API may comprise one of a RESTful API, a SQL based API, or an XML or JSON based API. The user interface may be configured to manage, based on an associated user's position, one or more of permission to update the database, permission to remove data from the database, or permission to allow other users to access the database. The correlation between the one or more targets to the data is updated based on data received substantially continuously and in real-time.

According to another embodiment of the disclosure, a method is provided for data and security management. The method may include capturing data relating to a plurality of targets from a plurality of sensors. The method may include correlating one or more targets to the data. The method may include classifying at least a portion of the data based on one or more correlations between the one or more targets and the data. The method may include storing in a database the data captured via the one or more correlation and search engines according to one or more of partitioning, complex indexing, or pre-search statistical processing. The data may comprise high volumes of data (e.g., about one million or more records per day) received substantially continuous and/or in real-time. The data may include one or more of time, date, and location data, among other data. The method may include retrieving a subset of the data and associated one or more of the time, date, and location data based on a user request. The method may include generating one or more graphical representations based on retrieved subsets of data and associated one or more of the time, data, and location data to thereby enable targeted tracking and analysis.

The method may further include storing unclassified remaining data in the database. The method may include purging the unclassified remaining data from the database after a period of time. The method may also include purging a selected portion of the portion of the data after a selected period of time.

In another embodiment, the database may be filterable based on one or more of time, date, and location data, among other factors or characteristics. The database may be accessible via a user interface. The method may further include specifying, via the user interface, the one or more targets.

Various objects, features, and advantages of the present disclosure will become apparent to those skilled in the art upon a review of the following detail description, when taken in conjunction with the accompanying drawings.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a schematic diagram of an example embodiment of a surveillance system according to principles of the present disclosure.

FIG. 2 is a schematic illustration of an example collection of identifying information in an intelligence database according to principles of the present disclosure.

FIG. 3 illustrates an example of data collected by the surveillance system and association thereof as patterns and signatures according to principles of the present disclosure.

FIG. 4 illustrates an example embodiment of the processing and association of factors collected and retrieved from a volume of data stored in the intelligence database using the methods according to embodiments of the present disclosure to determine correlations or associations of electronic signatures, known identifying data and other collected information to identify targets according to principles of the present disclosure.

FIGS. 5A-5C illustrate a user interface for a surveillance system according to FIG. 1.

FIG. 6 is a flow diagram illustrating an example methodology for analysis operations according to embodiments of the present disclosure.

The use of the same reference symbols in different drawings indicates similar or identical items.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

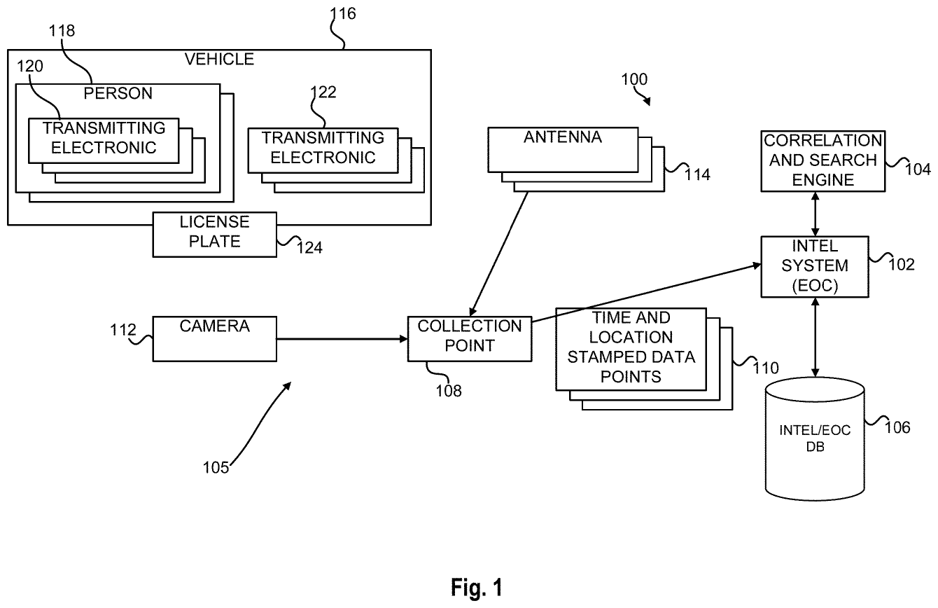

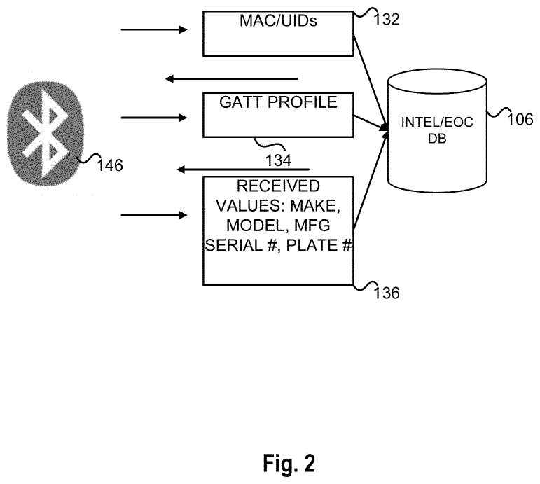

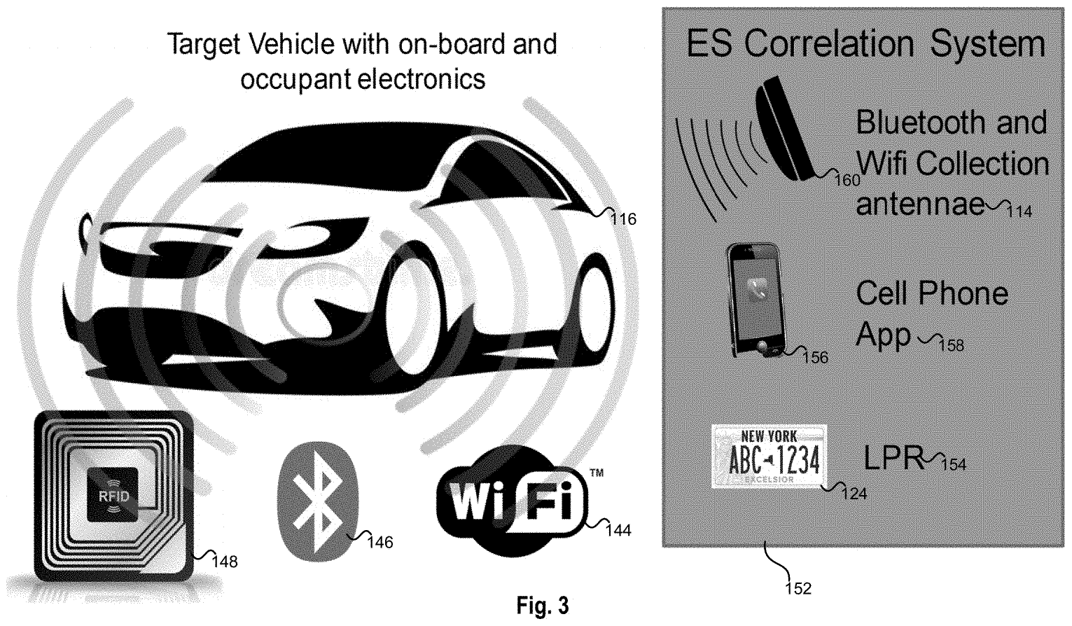

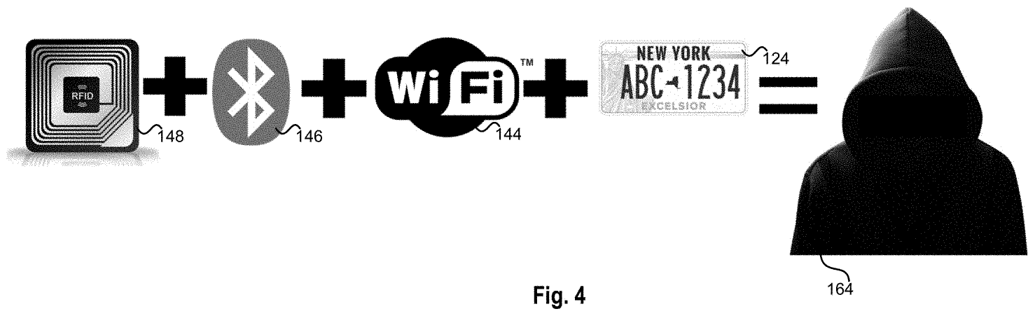

FIG. 1 provides a schematic diagram of an example embodiment of a surveillance system 100 for collecting and correlating electronic signatures and visual identifier information to build intelligence databases that facilitate tracking and associating indications of common location and movement of targets throughout selected geographic areas or locations at specified times. FIG. 2 illustrates an example collection of identifying information in an intelligence database 106 and FIG. 3 illustrates an example of data collected by the surveillance system 100 and association thereof as patterns and signatures. FIG. 4 illustrates an example embodiment of the processing and association of factors collected and retrieved from a volume of data stored in the intelligence database 106 using the methods according to embodiments of the present disclosure to determine correlations or associations of electronic signatures, known identifying data, and other collected information to identify targets.

The surveillance system 109 incorporates a database (e.g., an intelligence database 106) including a processing configuration/system for high volume processing support for the collection, storage, retrieval, search, and analysis of identifying data including support for database partitioning, complex indexing, pre-search statistical processing. The database processing system is designed to capitalize on a large (and growing) volume of incoming and stored historical information, including past reads of target plates and electronic signature information associated therewith to provide for substantially rapid analysis and updating of correlations between known target identifiers (e.g., a vehicle/license plate) and previously associated electronic signature information. For example, if a target changes vehicles, license plates, phones, etc., such changes can be recognized and updates/new correlations made with increased confidence based on processing of a larger volume of historical data pulled from the intelligence database.

Database structure, storage, and query techniques to support large dataset management for field data collection applications can be utilized for the intelligence database. Application of techniques including but not limited to indices, partitioning strategies, and summary data to make the implementation of high-volume ingestion, storage, retrieval, and disposal practical can be used. Methods for high-volume processing and storage of hundreds of millions of data elements daily into traditional storage infrastructure using highly tuned storage and search algorithms. Structures of data allowing high volume storage and purge of large daily volumes of field vehicle, person, electronic transmission source and image identification data.

The disclosed system and methods enable maintenance of data and user security through the application of a Domain structure across the large volume of data. Application of “Domain” as a security zone of collected data, users, and lists of target identifiers such that limitations of access to all types of data are managed through the Domain identification. Also provided is the ability to manage feature privileges for groups of users across a security domain structure providing user feature and data security across a broad enterprise and data model; and application of a set of externally visible methods through an application program interface (“API”) within the domain and group feature privilege model while maintaining performance at scale for high-volume data throughput.

As indicated in FIG. 1, the surveillance system 100 includes a plurality of collection systems 105 or assemblies that are located at selected geographic areas or locations. The collection systems 105 generally will be configured to capture or facilitate collection of information related to visual identifiers and/or electronic signatures associated with targets. The targets generally will include persons 118, vehicles 116, or a combination of both in and/or moving about the selected areas or locations. Targets also can include transmitted electronic devices 120, 122 or other objections, without departing from the scope of the present disclosure. The collection systems 105 can be positioned at various locations or collection points 108 about a specific geographic area, e.g., a municipality, county, other public or private areas, or combinations thereof.

FIG. 1 further shows an embodiment wherein each collection system 105 includes a sensor or sensor assembly configured to collect or otherwise capture the information related to visual identifiers and/or electronic signatures of targets. The sensor or sensor assembly accordingly can include one or more cameras 112 or camera systems configured to capture or facilitate collection of information related to vehicle identifiers, such as visual or imaged information related to a license plate of a vehicle and/or other visual vehicle identifiers that can be used to discern, detect and/or otherwise identify or confirm the identity of a target vehicle. Such collected identifying information will be supplied to and can be accessed from the intelligence database 106 as schematically indicated in FIG. 2.

For example, in some aspects, such vehicle markings can include, but are not limited to, signage, stickers, bumper stickers, non-license plate tags, patterns, position or configuration of component parts, damage to the vehicle, such as scratches, dents, repair marks, etc. and the location thereof on the vehicle, small markings or symbols or other indicia on vehicle components, as well as various other identifiable visual markings, or combinations thereof. In some embodiments, the camera system also can include an Automated License Plate Reader (“ALPR”) integrated or otherwise associated with a collection system 105, or the surveillance system can include ALRPs in addition to, or in place of, one or more collection systems 105.

In addition, or in the alternative, the at least one sensor or sensor assembly also can include an antenna 114, antenna array, or plurality of antennas configured to capture or otherwise receive electronic signals from transmitting electronic devices 120, 122 associated with the targets for identification/extraction of electronic signatures. The at least one sensor or sensor assembly can include additional sensors, such as IR sensors or other light sensors, without departing from the present disclosure. Other information or data may be obtained from other sources (e.g., a cellular phone 156) via other sensors and/or other algorithms or instructions (e.g., cellular phone applications 158).

As indicated in FIGS. 3, the transmitting electronic devices include, but are not limited to, transmitting electronic devices associated with a vehicle, such as vehicle components including, but not limited to, tire pressure sensors or other manufacturer installed or after-market vehicle sensors, vehicle stereo or entertainments systems, vehicle navigation systems, vehicle infotainment systems, self-driving or driver assist vehicle guidance systems, vehicle Wifi hotspots, other components of internal or external vehicle systems, etc. . . . ; and additionally can include transmitting electronic devices 120, 122 associated with persons or other types of targets, including, but not limited to, cellular phones and/or other communication devices, tablets, laptops, smart watches, fitness trackers, wireless headphones, RFID tags (e.g., key cards, library books, assets tags, pallet transmitters, pet collars), Wifi hot spots, and other personal electronic devices 160.

Each sensor or sensor assembly is configured to capture or collect signals transmitted by or otherwise emanating from the transmitting electronic devices 120, 122 when the targets get within proximity of the collection systems 105. The collection systems 105 can be configured to receive signals at a prescribed or selected proximity in relation thereto. For example, in some embodiments, the collection systems 105 could be configured to look for and receive signals transmitted within about 200 feet of the collection systems 105; while in other embodiments, such as to reduce or limit extraneous noise or to help filter such noise, shorter ranges of signals also can be used, i.e. in some locations, the collections systems can be configured to receive signals transmitted within about 100 feet of the collection systems 105, and in still other embodiments or locations, signals transmitted within about 50 feet of the collection systems 105. Other, varying ranges also can be used.

In addition, the surveillance system 100 includes an intelligence system 102 that is in communication with the plurality of collection systems. The intelligence system 102 is configured to receive information collected or captured by the collection systems 105 and to identify and/or track targets or correlate a target with other targets or electronic devices based on this received information (e.g., time and location stamped data points or information 110). The intelligence system 102 can be in wireless communication with the collection systems 105, e.g., through a public or private network using Wifi, cellular, etc. . . . . In addition, or in the alternative, the intelligence system 102 and one or more of the collection systems 105 can be connected through one or more wired connections. In this regard, when targets come within proximity of the collection systems 105, the collection systems 105 will collect visual information and/or electronic signal information associated with the targets and transmit data points or packets of information, e.g., time and location stamped information 110, related to collected visual and/or electronic signal information to the intelligence system. Such data packets can be used to develop and identify patterns, even though the individual data, by itself, may not be sufficient to generate a positive identification and/or correlation with a known target.

The collection systems 105 can be configured to transmit data points or packets substantially simultaneously or generally in real time when targets come within proximity to the collection systems 105. For example, the collection systems 105 can send a data point including information corresponding to each electronic signal or visual identifier as it is captured or can send a data packet including information corresponding to multiple electronic signals or visual identifiers received. In addition, or in the alternative, the collection systems 105 can transmit the data points or packets at specific time intervals, such as every few seconds, minutes, hours, etc. or at other times or intervals after the electronic signals or visual identifiers are captured, without departing from the scope of the present disclosure.

FIG. 1 further shows that the intelligence system 102 will include a correlation and search capabilities or one or more correlation and search engines (e.g., correlation and search engine 104 or the ES correlation system 152 of FIG. 3) and an intelligence database 106. The correlation and search engine 104 is configured to identify or extract electronic signatures and/or other targets associated with a target using collected visual and/or electronic signal information at the collection systems 105. In particular, the correlation and search engine is configured to ingest or process the data points/data packets to associate or correlate the visual identifiers with the received electronic device signals and/or other visual identifiers of other targets to facilitate the identification or extraction of electronic signatures and/or other information identifying the targets. The electronic signatures can include information related to the collected electronic signals of the transmitting electronic devices 120, 122 or combinations of collected electronic signals of the transmitting electronic devices 120, 122 that uniquely identify the targets. For example, and without limitation, a combination of one or more signals from a plurality of transmitting electronic devices 120 (e.g., a watch, cell phone/communication device, headphones, etc.) can include an electronic signature that uniquely identifies a person 118 (e.g. the electronic signature may be received as or may include a MAC user ID 132 and/or a GATT profile 134); a combination of one or more signals from a plurality of transmitting vehicle components 122 (e.g., a vehicle sensor, infotainment system, etc.) can include an electronic signature that uniquely identifies a vehicle 116, or one or more signals from a transmitting electronic device 120, 122 can include an electronic signature that uniquely identifies that electronic device.

The correlation and search engine 104 further can be configured to filter or otherwise alter the received electronic signatures (or information related thereto) to reduce or diminish signal noise and facilitate identification or extraction of unique, identifying electronic signatures. For example, the correlation and search engine 104 can apply filtering (e.g., linear or non-linear filters, dynamic noise reduction, etc.) to collected electronic signals to diminish, reduce, or substantially eliminate stationary and variable noise and other values that cannot be usefully correlated with targets, allowing unique electronic signal values to be extracted or identified.

In addition, the correlation and search engine 104 is configured to catalogue the electronic signatures and/or visual identifiers in the intelligence database 106 with specific identifying characteristics allowing these identified electronic signatures and/or visual identifiers to become unique, identifiable, and searchable. The identifying characteristics can include, but are not limited to, geographical coordinates, time stamps, source manufacturer, source type and unique ID, etc. . . . . The correlation and search engine 104 also can be configured to build catalogs or groupings of independent data points/data packets in the intelligence database 106 that allow correlation analysis to show what otherwise anonymous or non-unique electronic signals and/or other visual identifiers (e.g., other license plates) consistently appear with the targets. The surveillance system 100 thus can identify, track, map, catalogue, etc., the presence and/or movements of the targets in real time as electronic signals emanating therefrom occur in proximity to the collection systems 105 or based on image captures of visual identifiers. The surveillance system 100 further can generate alerts or notifications when certain targets are in proximity to the collection systems 105. Still further, the surveillance system allows for the searches or queries of the intelligence database 106, e.g., for investigating locations or movements of suspects or other persons of interest.

In embodiments, the correlation and search engine 104 can use algorithms, models, statistical models, machine learning algorithms/models, Big Data analysis or statistics, etc., to infer relationships between transmitting electronic devices 120, 122 and/or targets based on consistency or likelihood of correlation of the visual identifiers and/or electronic signals of the transmitting electronic devices. For example, the correlation and search engine 104 can be configured to evaluate and combine singular collection events at the collection systems 105 with other catalogued events in the intelligence database to develop correlated information related to the intersection of multiple collected/captured electronic signals and/or visual identifiers that occurred at a specific time and geographical area or location. The correlation and search engine 104 can use the frequency and/or consistency of electronic signals and/or visual identifiers received at collection systems 105 to determine the relative certainty of association of the transmitting electronic devices and/or targets to develop electronic signatures (correlated electronic devices) or correlated targets (e.g., correlated license plates) for the targets.

The correlation and search engine 104 can be programmed to determine a likelihood or probability that a specific electronic signal, a combination or set of electronic signals, and/or other target or targets are associated with a target, and if the determined likelihood or probability meets a prescribed/selected likelihood or probability threshold, the engine will identify or extract an electronic signal or combinations of electronic signals as an electronic signature or electronic signatures to be associated with that target. In one embodiment, the likelihood or probability threshold can be about 70% or more (e.g., above 75%, above 80%, above 85%, above 90%, above 95%, above 98%, etc.) that an electronic signal, combination/set of electronic signals, and/or other targets are associated with a particular target.

For example, the correlation and search engine 104 may correlate two or more license plates and one or more electronic devices based on multiple events that such a combination is received. Based on such a correlation, a prediction of when a particular vehicle may be present at a specific location may be determined by the correlation and search engine 104. Further, the two or more license plates may be from or may define a convoy (e.g., group of vehicles). In such an example, the electronic devices may be associated with the convoy.

In some embodiments, the correlation and search engine 104 can be configured to determine or identify a location at which a visual identifier and correlated electronic signature and/or other visual identifier are matched to enable tracking and/or verification of targets at such a location. In addition, or in the alternative, the correlation and search engine 104 can be configured to associate identifying electronic signatures and/or other visual identifiers with visual identifiers, such as a visual vehicle identifier, to allow independent tracking and location identification of targets based on the associated identifying electronic signatures and other visual identifiers, such as indicated in FIG. 4.

For example, once the engine has records correlating electronic signatures and/or other visual identifiers, e.g., a license plate 124 likely to be located at or near a specific visual vehicle identifier, associated with the specific visual vehicle identifier, e.g., a specific license plate number, the correlation and search engine 104 will be able to detect the likely presence of a vehicle 116 and its associated license plate 124 without visual information of that specific vehicle, e.g., a camera 112 may or may not be used. Furthermore, the collection systems 105 can be placed in locations or areas not associated with vehicular traffic, such that the intelligence system 102 will be able to identify, and catalogue known electronic signatures away from the vehicles they have typically been associated with.

In this regard, in embodiments, the collection systems 105 can be used in conjunction with existing ALPRs in certain areas or locations (e.g., to capture, in an embodiment, plate reads, in addition to or as an alternative to capturing make & model information, etc., such as indicated at 136), allowing the intelligence system 102 to develop a subset of electronic signatures and/or other license plate reads associated with a license plate read at a moment in time and location. For example, one or more collection systems 105 can be positioned near or in close proximity to an existing ALPR to allow for correlation or association of received electronic signals with license plate reads. For example, one or more collection systems 105 can be positioned near or in close proximity to an existing ALPR, which is configured to capture license plate information 124 or other information comprising, known factors that are identifiable with a known target (e.g., a target such as indicated at 164 in FIG. 4). In addition, or in the alternative, an existing ALPR can be modified or retrofitted to include components of the collection point systems to enable collection of electronic signals with license plate reads. Further, in some embodiments, collection systems 105 with or near cameras or ALPRs can be used in connection with collection systems 105 without cameras or ALPRs, as generally indicated in FIG. 1. As a result, electronic data points from less expensive collection systems 105 can be used to provide more precise tracking than ALPR alone. That is, the lower cost collection systems 105 can increase collection density beyond the collection of ALPR or camera records, enabling data from both collection system types to be combined to provide more detailed intelligence and increased accuracy of verification or authentication of possible targets, including providing monitoring personnel (e.g. law enforcement, security or other personnel) with an increased level of confidence of locations of potential criminals, stolen or other vehicles of interest.

Additionally, or alternatively, collection systems 105 without cameras (or with cameras 112) can be positioned in areas or locations that cannot be accessed by a vehicle 116, such as on trains, near railways, around public buildings, etc., to enable collection of electronic signals from persons away from their vehicle, e.g., for cataloguing, tracking, mapping, etc. . . . positions or movements thereof.

The intelligence system 102 generally includes one or more processors, controller's, CPUs, etc., and one or more memories, such as RAM, ROM, etc., in communication with the one or more processors. And, the engine can include computer programming instructions stored in the one or more memories that can be accessed and executed by the one or more processors to facilitate execution of the processes thereof, e.g., correlation of information, identification and tracking of the targets, searching of the intelligence database, etc. . . .

The correlation and search engine 104 can process the information from the received data points or data packages to correlate the received signal information with the visual information to develop electronic signatures uniquely identifying each vehicle based on the received electronic signals or combinations thereof, and also can populate the intelligence database 106 with the signature information identifying each vehicle. As multiple license plates may be read at a time and multiple signals detected, correlation may occur when or if multiple data points exist for a particular vehicle. Operators then can search, query, and/or analyze the intelligence database 106 for identification, mapping, tracking, etc., of vehicles 116 and/or locations at specific times or days (e.g., Tuesday at 1 PM).

In some embodiments, the surveillance system 100 can be configured to capture an electronic signature and associated information from a target, and can associate such electronic signature, as well as associate other targets, and associated information with the target's identification, e.g., license plate number or other visual identifier, with the correlation and search engine 104, and then allow searches for or provide alerts or notifications on receipts of similar electronic signature information and/or visual identifier at one or more of the collection systems 105.

In an embodiment, the intelligence database 106 may include high volume processing support for the collection, storage, retrieval, search, and analysis of identifying data. Such high volume processing support can include database partitioning, complex indexing, and/or pre-search statistical processing, among other techniques.

In an embodiment, database partitioning may include horizontal partitioning or sharding, vertical partitioning, or functional partitioning. Horizontal partitioning can include creating tables with the same schema for each partition for a particular dataset. In such examples, the partitions may be based on reads or captures for a particular month, reads or captures associated with particular correlations, or reads or captures of a particular interest (e.g., vehicles associated with a particular convoy, vehicles associated with a particular person, vehicles of no interest, vehicles involved in a known investigation, etc.), among other types of reads or captures. Vertical partitions can include subsets of fields for records in the intelligence database 106. For example, more frequently accessed or utilized reads or captures can be in a partition, while less frequently accessed or utilized reads or capture can be in another partition. Functional partitioning can include organizing or aggregating data for a partition based on the use of the data. In an embodiment, one, two, or more of the described partitioning techniques, among other partitioning techniques as will be understood by a person skilled in the art, can be utilized.

In an embodiment, complex indexing can include creating keys for each record or data entry in a first column. The second column can include a data reference or pointer indicating where the actual data is included in a non-transitory machine readable storage medium. The indexing can be utilized to quickly access data. For example, keys can be created for each record based on time captured. Further, a sparse index can be used, such that records for a particular day that are of no interest can include the same key or one key can be utilized for a first set of blocks of data for a particular day. As new reads or captures are taken for a particular day, old reads and captures from the oldest data reads and captures available may be deleted. In such examples, some data may be retained, such as data related to ongoing investigations or data related to reads or captures of interest and/or reads or captures associated with specified targets and/or convoys. Further, such data to be retained may be stored in a separate partition or database designated for data retention.

In an embodiment, pre-search statistical processing may be performed. As records are read or captured, data may be analyzed. Based on such an analysis, relevant data (e.g., data related to an investigation, convoy, or person or vehicle of interest) may be stored in such a manner that the data is accessed easier and/or quicker.

In an embodiment, the intelligence database 106 may utilize partitioning, indexing, pre-search statistical processing, or some combination thereof. Such use of one or more of the techniques described above make the implementation of high-volume (e.g., hundreds of millions of data elements, such as field vehicle, person, electronic transmission source and image identification data, recorded on a daily basis in traditional storage infrastructure) ingestion, storage, retrieval, and disposal practical.

In another embodiment, the graphical or web-based user interface can include a data maintenance and/or security maintenance interface to manage data and user security via the application of a Domain structure across the large volume of data. Different portions of collected data may be tagged with different levels of security. Based on such a tag, different users, based on their privilege set in the data maintenance and/or security maintenance interface, can access different sets of data. Further, the type of access can be restricted in the data maintenance and/or security maintenance interface (e.g., read only or read and write). In other words, a user's access or security level can be set in the data maintenance and/or security maintenance interface and, based on the access or security level, the user can have access to a specified set of the data. Such a data maintenance and/or security maintenance interface can connect to the intelligence database via an application program interface (“API”) (e.g., RESTful API a SQL based API, XML or JSON based API, etc.).

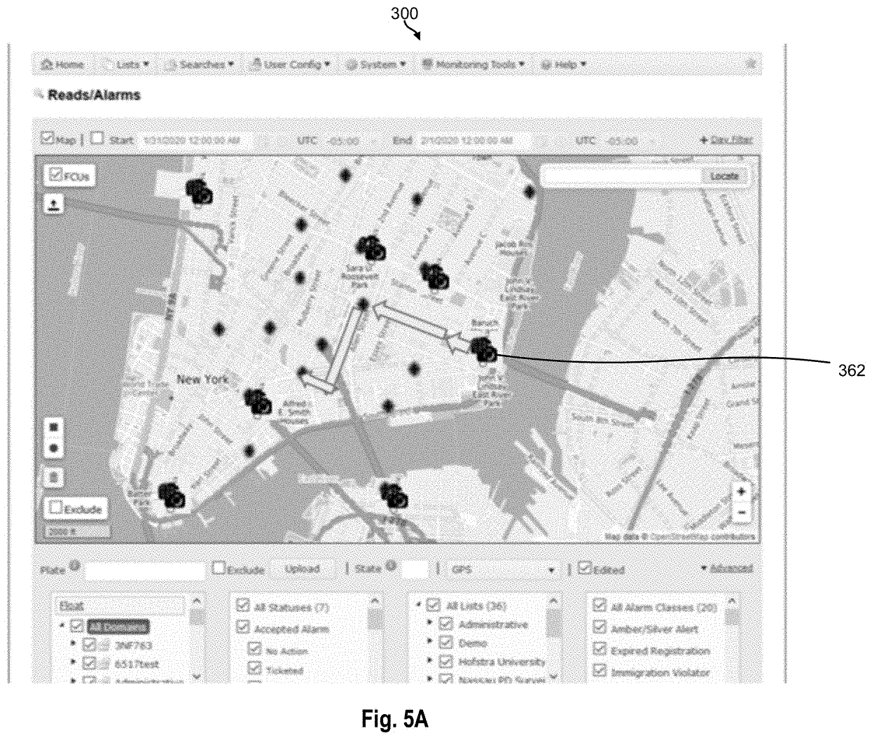

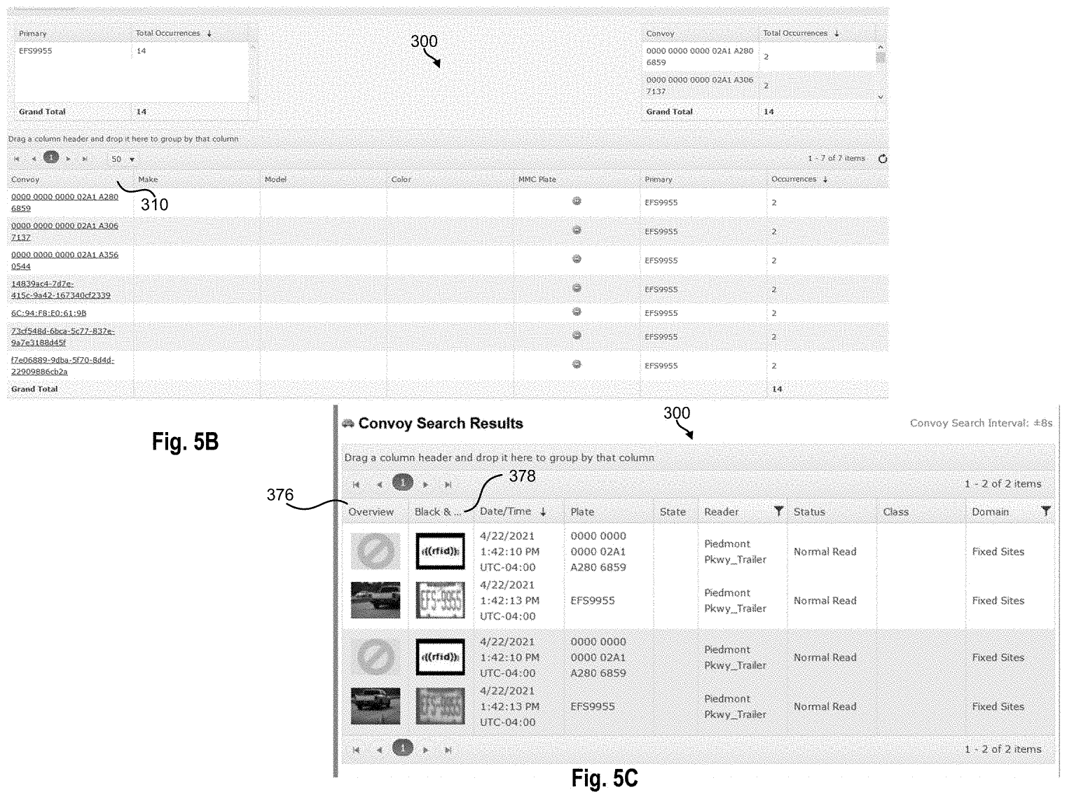

FIGS. 5A-5C illustrate an example of a graphical or web-based user interface 300 included with or utilizing the system of FIG. 1, particularly, the intelligence database 106. One or more electronic signature transmitting devices that can be associated with a target (e.g., a vehicle or person). For example, a target can emit many different signals from many different devices, including the vehicle itself, such as Bluetooth low energy signals, Bluetooth classic signals (e.g., audio protocol signals), Bluetooth signal signatures 146, WiFi 144, RFID 148, or other signals. Such signals may be generated by a number of devices, including, but not limited to headphones, cellular phones (e.g., cellular signals or WiFi signals via mobile hotspot functionality), laptops, tablets, personal items or wearable devices (e.g., smart-watches or other wearable smart devices), key locators, pet trackers, other tracker devices, mobile hotspots, or tire pressure and/or other vehicle safety equipment.

The devices described herein emit signals. These signals may be referred to as BLE Advertising, which can change or “hop” to different frequencies. For example, a smart watch or fitness tracker can use 2-3 channels or frequencies to send short bursts of information/packets (advertisements) at regular, limited time intervals. Some of these signals may be too weak to be picked up by various different receivers, depending on range, which can create consistency issues, such that some electronic signatures/signals can appear to be associated with more than one target vehicle. By utilizing a large database (e.g., such as the intelligence database 106 of FIG. 1) of reads and signatures, which can be updated via machine learning/modeling, closer and more accurate correlations and/or associations between electronic signature information and known target identification information (vehicle plate, make & model, etc.) can be made.

For example, an investigator can search for a license plate or a convoy and identify correlated electronic signals associated with a particular license plate or convoy, as shown in FIGS. 5A through 5C. Further, rather than tracking targets via only ALPRs or LPRs data may be gathered via other, potentially less expensive, collectors or collection points (e.g., a collection point to collect or track electronic signals, in addition to or rather than capture images). Electronic data points from these collectors can then be used to provide more precise tracking than LPR alone.

In such examples and as illustrated in FIGS. 5A through 5C, a suspect's or target's devices can be scanned and the identifiers used to search known location data points in the database history, placing the suspect at those locations and times. As such a database can include large amounts of data, the methods described above to manage such a database can ensure quick and efficient correlation and/or data gathering/searches. Further and for example, a user and/or investigator can label a signal matching a watch manufacturer with a suspect and then alert or search for history of that device or devices in the database, placing the target at more locations than LPR alone. Variations in electronic signature pattern can indicate changes in association or travel of suspects and/or targets.

In another example, as illustrated in FIGS. 5A, user interfaces or “portals” can be created with co-located LPR and electronic signature coordinates. The lower cost electronic signature collection point and/or antenna can be densely distributed in specified locations to collect large amounts of data beyond that of LPR density, thus increasing tracking and correlation accuracy and efficiency. Such a combination provides detailed intelligence regarding target correlation and/or tracking.

In another example, the surveillance system 100 can be configured to allow for search inquiries or scans of one or more specific electronic signatures associated with a target or convoy 310 or may search for a specific convoy or target associated with one or more convoys, and to provide search results including known location data points and/or known routes at specific times, in the intelligence database 106, placing the suspect at those locations and times. The search results can include maps 362 or other images showing the collection systems that captured electronic signals associated with the one or more electronic signatures searched, e.g., indicating the selected targets or convoy's presence or movements about a prescribed location or area (FIGS. 5A through 5C).

In addition, or in the alternative, the search results can include groupings or listings of search results associating the target, electronic signals, and/or convoy searched with information related to the collection systems which captured target, electronic signals, and/or convoy associated with the two or more targets and/or one or more electronic signatures searched (e.g., see FIG. 5C). The grouping or listing can include images 376/378 captured (e.g., images of the person, vehicle, vehicle license plate, etc.), temporal information (e.g., the date and time the visual or signal information was collected), the visual identifier (e.g., license plate number), location information (e.g., GPS coordinates, state, city, etc.), information identifying the collection point system, statues of the collection (e.g., normal read, error, etc.), etc. . . .

In another example, as illustrated in FIGS. 5B through 5C, convoy searches can include various electronic signatures associated with each target in the convoy or a particular target in the convoy. Convoy or target searches can be based on license plates and/or other vehicle or target characteristics.

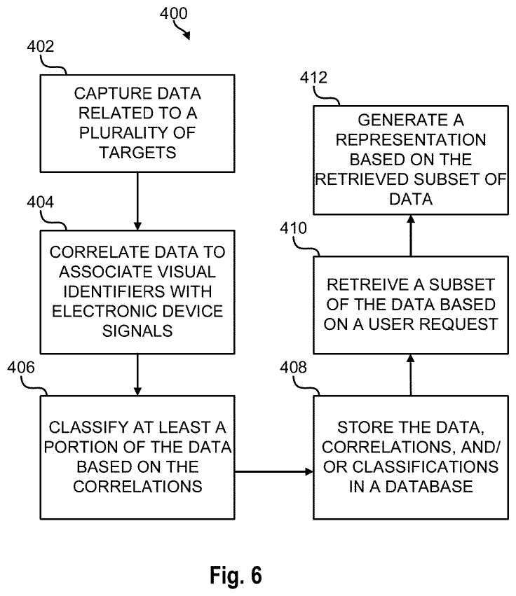

FIG. 6 illustrates a flow diagram for data and security management, according to an embodiment. The order in which the operations are described is not intended to be construed as a limitation, and any number of the described blocks may be combined in any order and/or in parallel to implement the methods.

At block 402, a surveillance system and/or intelligence system may capture data related to a plurality of targets. The data may comprise one or more of an image or visual indicator or identifier, a license plate number, an electronic signal, date and/or time data, or other data as indicated herein. At block 404, the surveillance system and/or intelligence system may correlate the data. Such a correlation may associate, for example, a visual identifier may be associated with an electronic device signal or an electronic device signal may be associated with a visual identifier. At block 406, the surveillance system and/or intelligence system may classify at least of a portion of the data based on correlations. In another embodiment, all data received may be classified (e.g., of interest or of non-interest, in an embodiment). Other classifications may be utilized (e.g., such as indicators to indicate a level of interest, the indicators being numbers, letters, or another indicator).

At block 408, an intelligence database may receive and store the data. The intelligence database may store such data according to one or more of partitioning, complex indexing, or pre-search statistical processing. In an embodiment, the data received may be of a large or high-volume in relation to typical database operations. For example, the intelligence database may receive millions of records each day.

At block 410, the intelligence database may allow for retrieval of a subset of the stored data. The intelligence database, the surveillance system, and/or the intelligence system may include or may comprise a user interface. A user, the surveillance system, and/or the intelligence system may submit such a request for the subset of the stored data. In such examples, based on the configuration of the intelligence database, the retrieval of such a subset of the stored data may be completed in a brief or less than typical amount of time for databases with such large volumes. At block 412, the surveillance system and/or the intelligence system may generate a representation (e.g., for example, in a user interface) based on the subset of the stored data.

The foregoing description generally illustrates and describes various embodiments of the present disclosure. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present invention as set forth in the appended claims.

1. A surveillance system for data and security management, the system comprising:
one or more collection systems configured to:
capture, via one or more sensors, data associated with a plurality of targets from a plurality of sensors, the data including visual identifiers, electronic signals, or combinations thereof;
an intelligence system comprising:
one or more correlation and search engines each configured to:
correlate data received from the one or more collection systems to associate one or more of visual identifiers with the received electronic device signals or other visual identifiers of other targets to facilitate the identification of electronic signatures identifying the targets;
a database configured to:
receive one or more of the data or one or more correlations from the one or more correlation and search engines,
classify the data based on the one or more correlations,
store one or more of the data, the one or more correlations, or one or more classifications, according to one or more of partitioning, complex indexing, or pre-search statistical processing, wherein the data comprises high volumes of data received substantially continuously and in real-time, and wherein the data includes one or more of time, date, and location data; and
a user interface configured to:
retrieve a subset of the data based on one or more of the time, date, and location data based on a user request, and
generate one or more representations based on retrieved subsets of data to thereby enable targeted tracking and analysis.

2. The system of claim 1, wherein the data further includes one or more characteristics associated with the plurality of targets.

3. The system of claim 2, wherein the plurality of targets comprises persons, vehicles, or electronic devices.

4. The system of claim 3, wherein the characteristics comprise one or more of geographical coordinates, time stamps, source manufacturer, source type, unique ID, or electronic signature.

5. The system of claim 4, wherein the user request includes one or more of one or more specified targets, one or more times, one or more dates, one or more locations, or one or more characteristics.

6. The system of claim 4, wherein the electronic signature comprises information from one or more of Bluetooth signals, wireless signals, RFID signals, Wi-Fi signals, or cellular signals.

7. The system of claim 1, wherein the database is configured to remove or purge data classified as non-interest data after a selected period of time.

8. The system of claim 1, wherein the user interface connects to the database via an application program interface (API).

9. The system of claim 8, wherein the API comprises one of a RESTful API, a SQL based API, or an XML or JSON based API.

10. The system of claim 1, wherein the user interface is configured to manage, based on an associated user's position, one or more of permission to update the database, permission to remove data from the database, or permission to allow other users to access the database.

11. A method for data and security management, the method comprising:
capturing data relating to a plurality of targets from a plurality of sensors, the data to include visual identifiers, electronic signals, or combinations thereof;
correlating data received from the one or more sensors to associate one or more of visual identifiers with the received electronic device signals or other visual identifiers of other targets to facilitate the identification of electronic signatures identifying the targets;
classifying at least a portion of the data based on one or more correlations;
storing, in a database, one or more of the data, the one or more correlations, or one or more classifications, according to one or more of partitioning, complex indexing, or pre-search statistical processing, wherein the data comprises high volumes of data received substantially continuous, and wherein the data includes one or more of time, date, and location data;
retrieving a subset of the data and associated one or more of the time, date, and location data based on a user request; and
generating one or more representations based on retrieved subsets of data and associated one or more of the time, data, and location data to thereby enable targeted tracking and analysis.

12. The method of claim 11, wherein the high volume of data comprises greater than about one million records per day.

13. The method of claim 11, further comprising storing unclassified remaining data in the database.

14. The method of claim 13, further comprising purging the unclassified remaining data from the database after a period of time.

15. The method of claim 14, further comprising purging a selected portion of the portion of the data after a selected period of time.

16. The method of claim 11, wherein the database is filterable based on the one or more of time, date, and location data.

17. The method of claim 11, wherein the database is accessible via a user interface.

18. The method of claim 17, further comprising specifying, via the user interface, the one or more targets.
